(19) United States
(12) Patent Application Publication
(10) Pub. No.: US 2026/0218770 A1
(43) Pub. Date: Jul. 30, 2026

(54) VALVE FOR CONTINUOUS HYDRAULIC DAMPING FORCE REGULATION

(71) Applicant: Astemo, Ltd., Tokyo (JP)

(72) Inventor: Paramesh CHINTALA, Rochester Hills, MI (US)

(21) Appl. No.: 19/321,346

(22) Filed: Sep. 8, 2025

Related U.S. Application Data
(60) Provisional application No. 63/749,155, filed on Jan. 24, 2025.

(51) Int. Cl. F16F 9/34; B60G 13/08; B60G 17/015; B60G 17/08; F16F 9/18; F16F 9/46; F16K 31/40

(52) U.S. Cl. CPC F16F 9/34; F16F 9/18; F16F 9/465; F16K 31/406; B60G 13/08; B60G 17/0152; B60G 17/08; B60G 2202/24; B60G 2204/62; B60G 2206/41; B60G 2500/114; B60G 2600/184; B60G 2800/162; B60G 2800/916; F16F 2222/12; F16F 2228/066; F16F 2230/18; F16F 2232/08; F16F 2234/02

(57) ABSTRACT

Examples include a valve having a valve body with a central axis. A valve face is disposed on a first end of the valve body, the valve face including an outer surface and an inner surface that meet at an apex at which a circular valve seating surface is disposed. The inner surface is shaped as a first truncated cone converging in a first direction toward the valve body and the outer surface is shaped as a second truncated cone converging in a second direction away from the valve body. The inner surface has a first angle relative to the central axis and the outer surface has a second angle relative to a line extending from a circumference of the valve body and parallel to the central axis. The first angle of the inner surface is greater than the second angle of the outer surface.

### CROSS-REFERENCE TO RELATED APPLICATION

This application claims the benefit of U.S. Provisional Ser. No. 63/749,155, filed Jan. 24, 2025, which is incorporated by reference herein.

### BACKGROUND

Various types of dampers may be used in vehicle suspension systems to enhance ride comfort, vehicle stability, and vehicle handling. Traditional suspension systems may employ hydraulic dampers, but conventional hydraulic dampers may have limitations when attempting to adapt to changing road conditions and driving behaviors. For instance, existing semi-active damper technologies, such as semi-active hydraulic dampers (SAHDs), face several challenges including limited precision in adjusting damping forces, relatively slow response times to changes in road conditions, and inefficiencies in the dampers themselves that can reduce ride quality and vehicle stability.

### SUMMARY

In some implementations, a valve includes a valve body with a central axis. A valve face is disposed on a first end of the valve body, the valve face including an outer surface and an inner surface that meet at an apex at which a circular valve seating surface is disposed. The inner surface is shaped as a first truncated cone converging in a first direction toward the valve body and the outer surface is shaped as a second truncated cone converging in a second direction away from the valve body. The inner surface has a first angle relative to the central axis and the outer surface has a second angle relative to a line extending from a circumference of the valve body and parallel to the central axis. The first angle of the inner surface is greater than the second angle of the outer surface.

### BRIEF DESCRIPTION OF THE DRAWINGS

FIG. 1 illustrates a perspective view of an example pilot valve according to some implementations.

FIG. 2 illustrates a cross-sectional view of the pilot valve according to some implementations.

FIG. 3 illustrates a cross-sectional view of an example pilot body with the example pilot valve of FIGS. 1 and 2 aligned therewith according to some implementations.

FIG. 4 illustrates an example cross-sectional view of the pilot valve and pilot body 300 in an open condition for enabling fluid flow according to some implementations.

FIG. 5 illustrates a cross-sectional view of an example hydraulic control valve according to some implementations.

FIG. 6 illustrates an example damper incorporating the pilot valve according to some implementations.

FIG. 7 illustrates an example valve face configuration of a pilot valve according to some implementations.

FIG. 8 illustrates another example valve face configuration of a pilot valve according to some implementations.

FIG. 9 illustrates another example valve face configuration of a pilot valve according to some implementations.

FIG. 10 illustrates an example representative comparison plot of reaction forces predicted for the different valve face configurations at various pilot body pressures according to some implementations.

FIG. 11 illustrates another example configuration of a valve face and associated pilot valve according to some implementations.

### DETAILED DESCRIPTION

Some implementations herein are directed to techniques and arrangements for a pilot valve for hydraulic systems that can be used in various applications, which may include addressing challenges in vehicle suspension systems, such as for semi-active hydraulic dampers or the like. Some examples of the pilot valve herein enable precise, real-time adjustment of damping forces, thereby enhancing vehicle ride comfort and handling by allowing the vehicle suspension system to adapt to varying road conditions and driving styles. For instance, the improved responsiveness of the pilot valve herein may enhance vehicle performance by providing better stability, traction, and handling, while also offering a cost-effective solution as compared to more complex technologies such as fully active dampers or magnetorheological damping systems.

Examples of the damper with the pilot valve disclosed herein have improved damping force characteristics and precision, which allows for automatic, real-time, fine-tuned adjustments to suspension forces for providing better ride comfort and handling. Additionally, examples of the pilot valve herein can improve response times for enabling the suspension system to quickly adapt to changing road conditions, and for ensuring optimal vehicle stability and control. Further, the pilot valve herein provides a cost-effective solution as compared to more complex suspension technologies, and offers many of the benefits of the more complex technologies in a simpler solution and at significantly lower cost. In addition, examples herein may increase suspension system durability and reliability, while reducing maintenance requirements and increasing the lifespan of the suspension system.

Examples of the pilot valve herein, such as when used for semi-active hydraulic dampers, provide an advantage of balancing performance with simplicity and cost-efficiency. Further, the pilot valve herein may enhance an existing hydraulic system, such as by offering substantial improvements in responsiveness and control without requiring the full complexity or cost of alternatives like active damper control or magnetorheological damper control. As consumer demand grows for vehicles that offer both comfort and superior driving dynamics, the technology described herein allows for better suspension control, thereby optimizing vehicle safety and stability. Additionally, as fuel efficiency, sustainability, and regulatory compliance become more important, examples herein enable manufacturers to provide suspension systems that are more efficient, responsive, and durable.

In some implementations, the damping force performance of a damper may be improved, at least in part, due to a reduction in the force acting on a valve face of the pilot valve inside a hydraulic control valve of a damper. As one example, this may be achieved by optimizing a flow direction and a geometry of the valve face of the pilot valve. Examples herein may significantly reduce the fluid force on the valve face of the pilot valve, which results in improved damping force characteristics of an associated damper that employs the pilot valve herein. For instance, a change in flow direction may significantly enhance the damping performance of a damper. Accordingly, an improvement in the damping force characteristics may be due, at least in part, to a reduction in a force acting on the valve face of the pilot valve. This reduction in force may be a result, at least in part, of a novel valve face geometry described herein that modifies a fluid flow direction and that causes a decrease in fluid force on the valve face. Thus, examples herein include a pilot valve design that significantly enhances the damping force characteristics, precision, and performance of vehicle suspension systems, particularly in semi-active hydraulic dampers.

Some examples are directed to a semi-active hydraulic damper that includes a pilot valve according to the implementations herein. Semi-active hydraulic dampers use electromagnetic forces to deliver adjustable and precise damping control. The increasing demand for smart and connected vehicles is fueling the adoption of electromagnetic dampers, especially in high-end and performance-oriented models. In the context of a semi-active suspension system, the pilot valve herein plays a role in modulating the flow of fluid in the damper, thereby adjusting the damping force and improving vehicle performance. The pilot valve herein regulates fluid flow within the damper system to enable a suspension system to respond more swiftly, with greater precision, and exert higher forces, thereby meeting the increasing performance demands of modern vehicles.

For ease of understanding, some example implementations are described in the environment of a pilot valve for a hydraulic damper for a vehicle suspension system. However, implementations herein are not limited to the particular examples provided, and may be extended to other types of dampers, other types of pilot valve control systems, other types of hydraulic apparatuses that employ pilot valves, poppet valves, and so forth, as will be apparent to those of skill in the art in light of the disclosure herein.

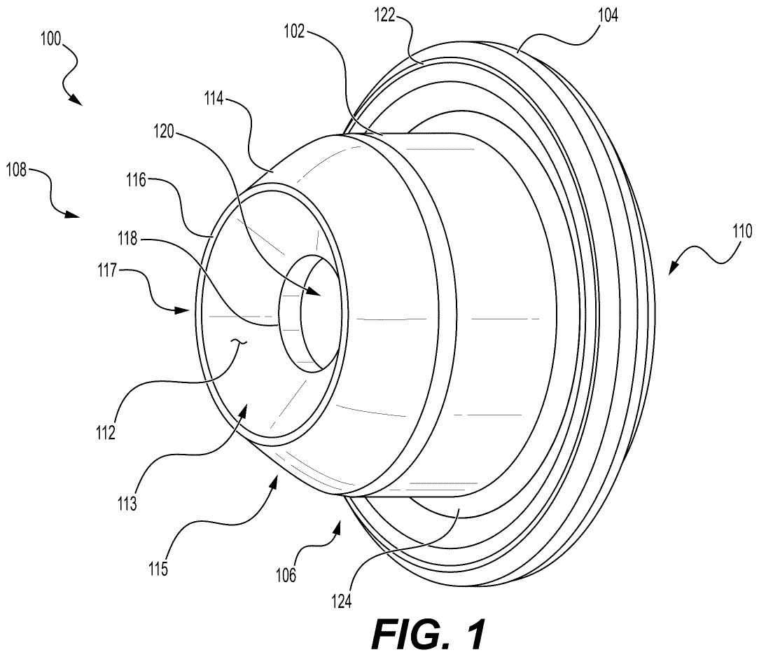

FIG. 1 illustrates a perspective view of an example pilot valve 100 according to some implementations. The pilot valve 100 includes a valve body 102 at least a portion of which is cylindrical in this example. The valve body 102 includes a circular flange 104 that extends radially outward from the valve body 102. A valve face 108 is disposed at a first end 106 of the valve body 102. The circular flange 104 is disposed near a second end 110 of the valve body 102. The valve face 108 includes an inner surface 112 and an outer surface 114. The inner surface 112 of the valve face 108 is shaped as a first truncated cone 113 converging toward the valve body 102 and the second end 110. The outer surface 114 of the valve face 108 is shaped as a second truncated cone 115 that is concentric with the first truncated cone 113 that forms the inner surface 112. The second truncated cone 115 forming the outer surface 114 converges in a direction opposite to the first truncated cone 113 of the inner surface 112 and converges in a direction moving away from the valve body 102, the first end 106, and the second end 110. A flat circular valve seating surface 116 is formed at an apex 117 at which the inner surface 112 and the outer surface 114 meet. The inner surface 112 extends away from the seating surface 116 in the direction of the valve body 102 and the second end 110 to terminate at an opening 118 that opens into an inner bore 120 of the cylindrical valve body 102.

The flange 104 includes an annular lip 122 on a side facing toward the valve face 108. The thickness of the flange 104 narrows between the annular lip 122 and a fillet 124 formed at a junction of the flange 104 with the cylindrical valve body 102. The pilot valve 100 may be constructed of metal, polymer, or other suitable material, such as by machining, casting, molding, forging, or combinations thereof. The material used may depend, at least in part on the intended application. Examples of suitable materials may include bronzes, Monels, Inconels, polymers, monomers, stainless steel, chrome/moly alloys, and so forth. The pilot valve 100 herein is not limited to any particular material or manufacturing process.

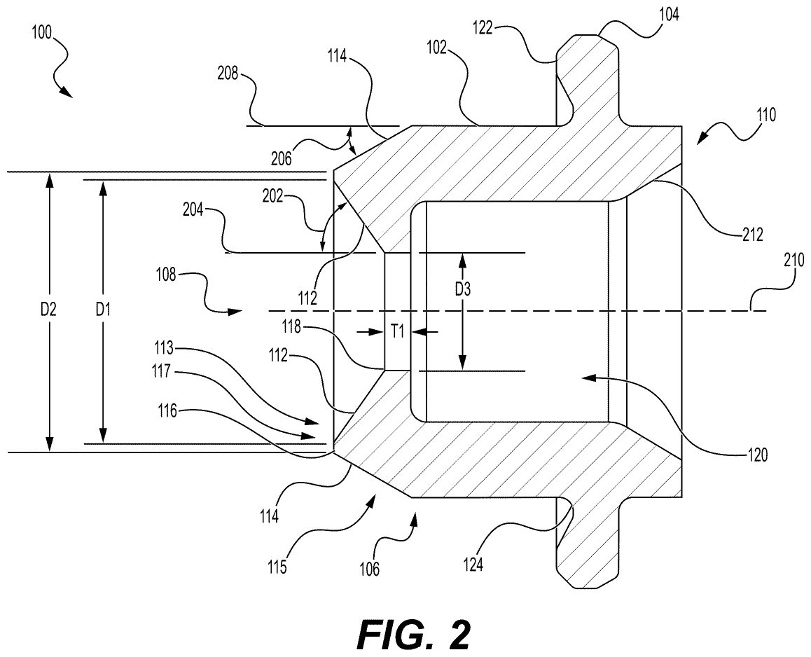

FIG. 2 illustrates a cross-sectional view of the pilot valve 100 according to some implementations. In this example, a first angle 202 of the inner surface 112 relative to a line 204 is greater than a second angle 206 of the outer surface 114 relative to a line 208. For instance the line 204 may be parallel to a central axis 210 of the pilot valve 100. Additionally, the line 208 may extend from a circumference of the cylindrical valve body 102 in a direction parallel to the central axis 210 of the pilot valve 100. Further the pilot valve 100 may be generally radially symmetrical about the central axis 210 when viewed from either end 106 or 110 of the pilot valve 100. In some examples, the first angle 202 may be between 30 and 80 degrees, and the second angle 206 may be between 0 and 45 degrees, while still maintaining the first angle 202 to be greater than the second angle 206 to provide optimal responsiveness to hydraulic forces. Further, in some particularly advantageous examples that may provide a substantial reaction force reduction, the first angle 202 may be between 45 and 65 degrees, and the second angle 206 may be between 20 and 40 degrees.

The described configuration of the valve face 108, in which the first angle 202 of the inner surface 112 is greater than the second angle 206 of the outer surface 114 helps to reduce the fluid force within a hydraulic system that employs the pilot valve 100. For example, the configuration of the valve face 108 may help to optimize fluid flow. As one example, in the case that the pilot valve 100 is utilized in a hydraulic control valve of a damper of a vehicle suspension system, the configuration of the valve face 108 contributes to more efficient damping control and improved suspension performance by enabling the pilot valve to move to an open (unseated) position under a lower fluid pressure than in the case of conventional pilot valve designs.

In addition, in some damper applications, the valve face 108 of the pilot valve 100 may be positioned on the end of a plunger (not shown in FIG. 2) such as a solenoid controlled plunger, or the like, and with the valve face 108 facing toward a fluid flow inlet, as discussed additionally below. For instance, the valve face 108 is configured with the first angle 202 of the inner surface 112 being greater than the second angle 206 of the outer surface 114 to effectively guide the flow of hydraulic fluid through a hydraulic system that incorporates a hydraulic control valve including the pilot valve 100 and a solenoid. This improved fluid flow enhances the precision and responsiveness of the hydraulic control valve of the damper. Consequently, examples herein address issues in conventional pilot valve technology by introducing features in pilot valve design that enhance fluid flow control, allowing for more precise regulation of hydraulic fluid within a damper, or the like. This improvement directly contributes to more accurate adjustments of the damping force characteristics, enabling, for example, a semi-active hydraulic damper to respond more effectively to dynamic changes in driving conditions and road surfaces.

Additionally, as discussed in some examples below, the inner bore 120 of the pilot valve body 102 may include an opening 212 at the second end 110 of the valve body 102. The opening 212 at the second end 110 may be conical in shape or may be otherwise tapered or enlarged toward the second end 110, such as to enable easier insertion of a plunger of a solenoid or the like (not shown in FIG. 2).

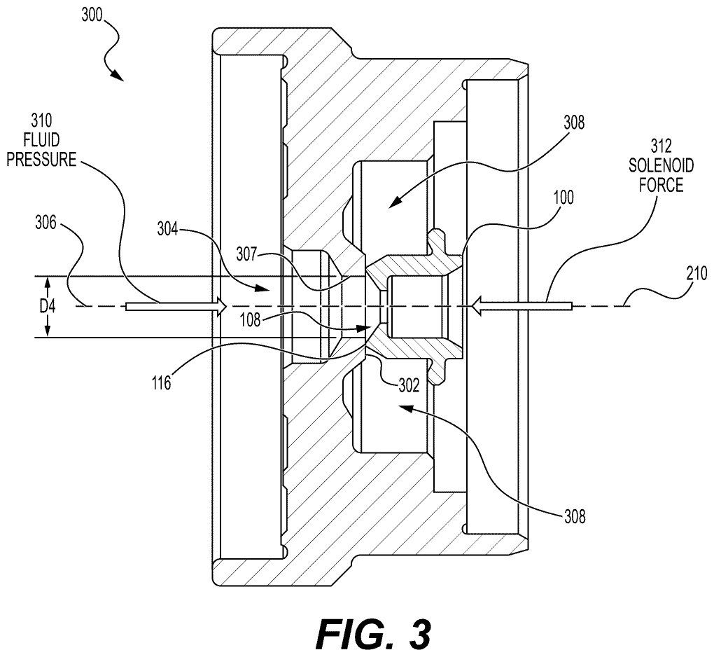

Furthermore, the valve seating surface 116 may have an inner diameter D1 and an outer diameter D2. The difference between the diameter D1 and the diameter D2 is dependent in part on the relative relationship between the first angle 202 of the inner surface 112, the second angle 206 of the outer surface 114, and may also depend in part on a diameter D3 of the opening 118. The diameter D3 may be maintained to allow entry of static fluid under pressure as discussed below. However, as also discussed below, holding the diameter D3 constant in examples implementing different first angles 202 for the inner surface 112 may result in different thicknesses T1 of the opening 118 between the valve face 110 and the valve inner bore 120. Additionally, the diameter D1 also may also be sized based in part on a diameter of an opening of a valve seat (discussed below with respect to FIG. 3) with which the valve seating surface 116 forms a seal. For example, reducing the diameter D1 of the valve seating surface 116 relative to the size of the opening at the valve seat can help improve the responsiveness of the pilot valve 100, and thereby improve the responsiveness of a damper or other device in which the pilot valve 100 is installed.

FIG. 3 illustrates a cross-sectional view of an example pilot body 300 with the example pilot valve 100 of FIGS. 1 and 2 aligned therewith according to some implementations. In this example, the pilot valve seating surface 116 of the pilot valve 100 is shown in contact with a circular valve seat 302 of the pilot body 300. The pilot valve 100 aligns with a fluid flow path 304 of the pilot body 300, and the central axis 210 of the pilot valve 100 aligns with a central axis 306 of the pilot body 300. The flow path 304 includes a flow opening 307 having a diameter D4 that opens in the center of the valve seat 302 so that the pilot valve seating surface 116 forms a circular seal with the valve seat 302 around the flow opening 307. As mentioned above, the valve seating surface 116 may have an inner diameter D1 that is sized relative to the flow opening 307 so that the diameter D1 is not substantially larger than the flow opening D4, other than to allow for tolerances in manufacture, assembly, and movement of the pilot valve 100 relative to the pilot body, as discussed additionally below. As mentioned, the inner diameter D1 of the pilot valve seating surface 116 may be based in part on the relative angles of the first angle 206 and second angle 208 discussed above, which can also affect the size of the overall contact area of the valve seating surface 116 with the valve seat 302. For example, reducing the diameter D1 of the valve seating surface 116 relative to the diameter D4 flow opening 307 at the valve seat 302 can improve the responsiveness of the pilot valve 100, and thereby improve the responsiveness of a damper or other device in which the pilot valve 100 and pilot body 300 are installed.

The pilot body 300 further includes an annular fluid passage 308 around the pilot valve 100 such that when the pilot valve seating surface 116 moves away from the circular valve seat 302 of the pilot body 300, fluid is able to flow through the fluid flow path 300 of the pilot body and into the annular fluid passage 308. The configuration of the valve face 108 of the pilot valve 100 contributes to the improved responsiveness and precision of the pilot valve 100 for enabling passage of the fluid into the annular fluid passage 308.

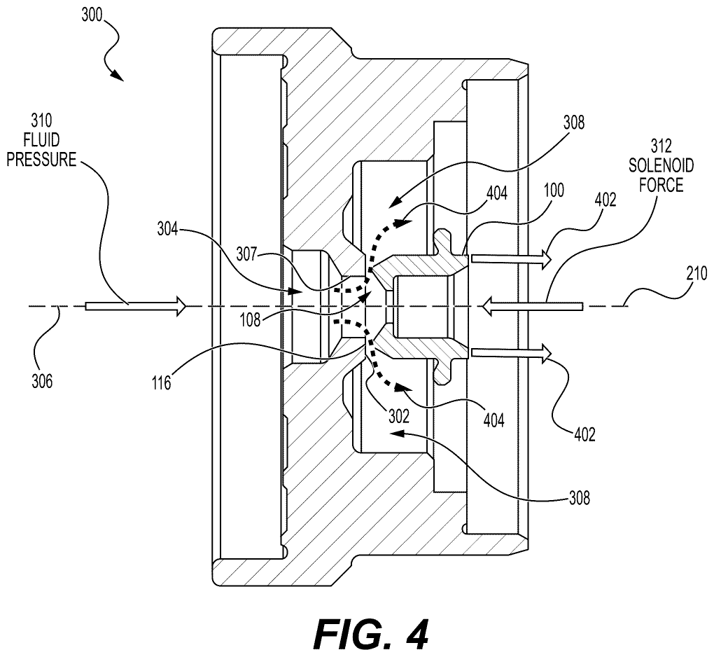

For example, fluid pressure 310 may be applied to the face 108 of the pilot valve through the fluid passage 304 and the fluid opening 307. The fluid pressure 310 may be opposed by a solenoid force 312 that presses the pilot valve seating surface 116 of the pilot valve 100 against the valve seat 302 of the pilot body 300. As discussed below with respect to FIG. 4, when the fluid pressure 310 exceeds the solenoid force 312, the pilot valve is unseated from the valve seat 302 and fluid is able to flow into the annular fluid passage 308.

FIG. 4 illustrates an example cross-sectional view 400 of the pilot valve 100 and pilot body 300 in an open condition for enabling fluid flow according to some implementations. In this example, in a first state, as illustrated in FIG. 3 discussed above, the pilot valve seating surface 116 of the pilot valve 100 is in contact with the valve seat 302 of the pilot body 300 to prevent fluid flow from the fluid passage 304 into the annular fluid passage 308. For instance, the solenoid force 312 may press the pilot valve 100 against the valve seat 302 of the pilot body 300 causing a seal to be formed between the valve seating surface 116 and the valve seat 302. However, in the illustrated example of FIG. 4, the fluid pressure 310 in the fluid passage 304 may increase sufficiently to push against the valve face 108 of the pilot valve 100 so as to move the pilot valve 100 away from the valve seat 302, as indicated by arrows 402. The movement of the valve seating surface 116 and the pilot valve 100 away from the valve seat 302 enables fluid to flow from the fluid passage 304, past the valve seating surface 116, and into the annular fluid passage 308 in the direction of fluid flow arrows 404.

As one example, as discussed additionally below, movement of a damper piston (not shown in FIG. 4) may increase the fluid pressure 310 in the direction of the pilot valve 100, and the higher pressure may push the pilot valve 100 in the direction of arrows 402 against the solenoid force 312 and away from the valve seat 302, thereby enabling the fluid to flow in the direction of fluid flow 404 through the annular passage 308. As mentioned previously, the configuration of the valve face 108 in the examples herein may increase the responsiveness of the pilot valve by reducing the amount of fluid pressure 310 needed to unseat the pilot valve 100 from the valve seat 302.

Furthermore, as discussed above, e.g., with respect to FIG. 2, the examples herein provide for optimized fluid force reduction based on the first angle 202 of the valve face inner surface 112 being greater than the second angle 206 of the outer surface 114 (see, e.g., FIGS. 1 and 2). Thus, the examples herein may include a specific design parameter where the first angle 202 is always greater than the second angle 206, which has an effect of reducing fluid force within a hydraulic control valve, or the like, that includes the pilot valve 100 and pilot body 300. When employed in a semi-active hydraulic damper, such as discussed additionally below, the valve face configuration described herein may improve fluid flow management and allow for more accurate control of damping forces, resulting in smoother suspension performance and better vehicle handling.

Examples herein incorporate an orientation of the valve face positioned toward the flow opening 307 of the flow channel 304. The valve face configuration herein may ensure optimal fluid flow guidance. For instance, the valve face 108 herein may enhance the responsiveness and efficiency of a damping system by directing fluid flow in a manner that maximizes performance and minimizes resistance, which helps to address certain limitations of existing hydraulic valve systems such as those mentioned above. As one example, the pilot valve configuration herein, when incorporated into a hydraulic control valve of a semi-active hydraulic damper, may provide a substantial improvement in the damping force characteristics for creating a more efficient, responsive, and cost-effective semi-active hydraulic damper having improved performance.

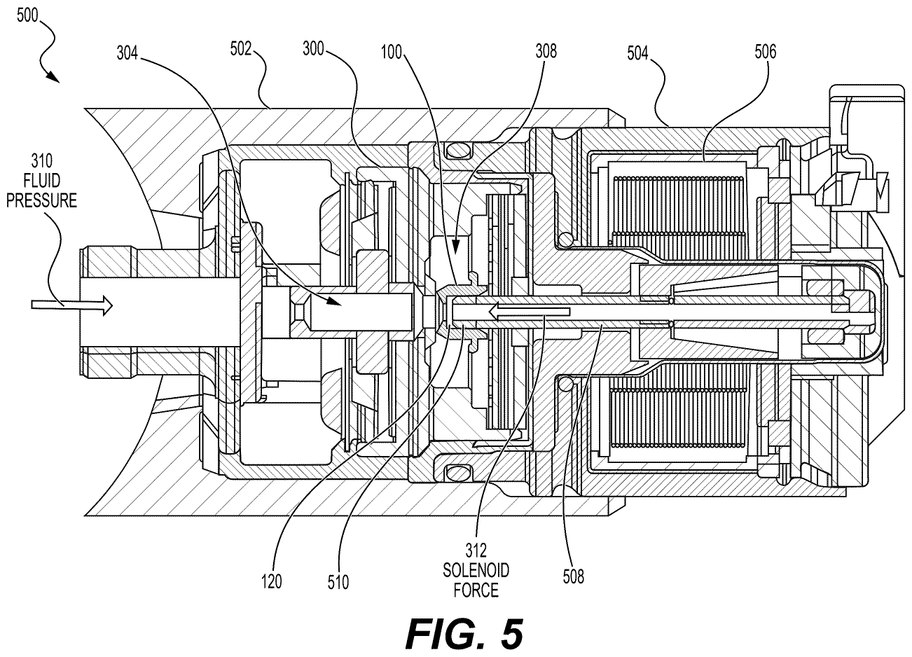

FIG. 5 illustrates a cross-sectional view of an example hydraulic control valve 500 according to some implementations. In this example, the pilot body 300 discussed above with respect to FIGS. 3 and 4 is disposed within an outer housing 502 of the hydraulic control valve. The outer housing 502 may be generally cylindrical, and may receive a portion of an inner housing 504 that may also be generally cylindrical and that is partially inserted into the outer housing 502. The inner housing 504 contains a solenoid 506 that includes a plunger 508. A plunger end 510 of the plunger 508 may be disposed within the bore 120 of the pilot valve 100. The solenoid 506 may be activated to apply the solenoid force discussed above with respect to FIGS. 3 and 4 in the direction opposed to the fluid pressure 310, thereby pressing the pilot valve 100 toward the valve seat 302 of the pilot body 300, as discussed and illustrated above with respect to FIGS. 3 and 4.

In a damper application, as illustrated, the valve face 108 of the pilot valve 100 may be positioned facing away from the solenoid and solenoid plunger which apply the solenoid force 312, and may face toward the fluid pressure 310, which may be flowing under pressure from the damper, as discussed above with respect to FIG. 4. The configuration of the valve face 602 helps to reduce the fluid force within a hydraulic system that employs the pilot valve 100 for effectively guiding the flow of hydraulic fluid through a hydraulic system that incorporates the hydraulic control valve 500 including the pilot valve 100. This improved fluid flow enhances the precision and responsiveness of a damper or other hydraulic system employing the hydraulic control valve 500 having the pilot valve 100 herein.

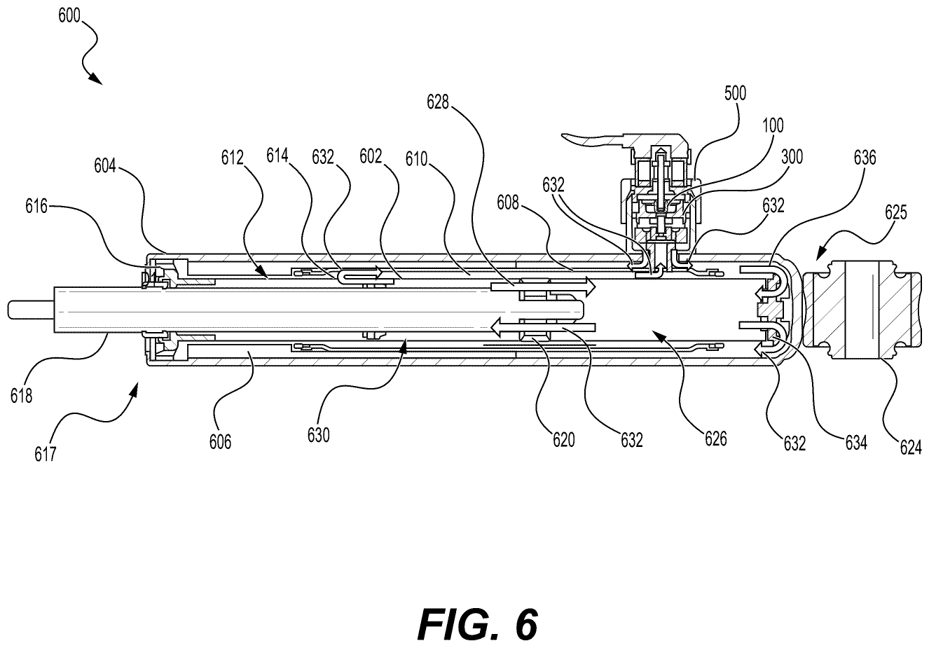

FIG. 6 illustrates an example damper 600 incorporating the pilot valve 100 according to some implementations. In the illustrated example, the damper 600 is configured as a semi-active hydraulic damper; however, other implementations herein are not limited to any particular damper configuration. In this example, the damper 600 includes an inner tube 602 that may serve as a pressure tube, and an outer tube 604 disposed around the inner tube 602 in a concentric manner. An annular space 606 serving as a gas chamber in some examples may be disposed between at least a portion of the inner tube 602 and the outer tube 604. An intermediate tube 608 may also be disposed in the annular space 606 and encircles at least a portion of the inner tube 602 in a concentric manner.

A hydraulic valve, such as the hydraulic control valve 500 discussed above is mounted on an exterior of the outer tube 604, and includes the pilot valve 100 and the pilot body 300. Another annular space 610 between the intermediate tube 608 and the inner tube 602 connects with an interior 612 of the inner tube 602 via one or more passages to enable fluid to flow between the interior 612 of the inner tube 602 and the annular space 610, and thereby to the hydraulic valve 500, which is in fluid communication with the annular spaces 606 and 612. The hydraulic control valve 500 may be configured for controlling, at least in part, the flow of hydraulic fluid within the damper 600.

A rod guide 616 is disposed at a first end 617 of the inner tube 602 and the outer tube 604. A piston rod 618 passes through a bore of the rod guide 616, and is able to reciprocate within the bore of the rod guide 616. A piston 620 is disposed on one end of the piston rod 618 and fits within the bore of the inner tube 602 for enabling reciprocal motion of the piston 620 and piston rod 618 within the inner tube interior 612. For instance, the piston 620 and piston rod 618 reciprocate within the inner tube 602 in response to external forces applied to the piston rod 618 and a damper mount 624 disposed on a second end 625 of the damper 600. As is known in the art, the interior 612 of the inner tube 602 may include a compression chamber 626 which the piston 620 moves toward during a compression stroke and a rebound chamber 630 that the piston 620 moves toward during a rebound stroke. A base valve 634 is located at the second end 625 of the damper 600 and controls fluid flow during compression and replenishment of fluid. Arrows 632 indicate fluid flow through the damper 600 and hydraulic control valve 500 during the compression stroke. Arrow 628 indicates fluid flow through the piston 620 during a rebound stroke. Arrow 636 indicates fluid flow into the compression chamber for fluid replenishment during the rebound stroke.

When the pilot control valve 100 is included in the damper 600, as shown in FIG. 6, the hydraulic functioning of the damper 600 is improved. For example, in a semi-active hydraulic damper, the fluid is metered through the rebound chamber 630 into the intermediate tube 610, and then through the pilot control valve 100 into a reserve chamber, such as in the annular space 606, no matter the direction of suspension movement. During the compression stroke in the suspension “soft” mode, the fluid flows from the compression chamber 626 to rebound chamber 630, into intermediate tube 610, through the pilot control valve 100, and into the reserve chamber. During stroke reversal, from compression to rebound, the compression chamber 630 is replenished through the base valve 634, as indicated by arrow 636. Thus, the pilot valve 100 in the example damper 600 may act as a two-stage hydraulic pressure control valve. For facilitating the implementation of semi-active suspension functionality on a vehicle, a semi-active hydraulic damper including the pilot valve 100 as described herein may be installed on at each wheel of a vehicle (e.g., one damper per wheel).

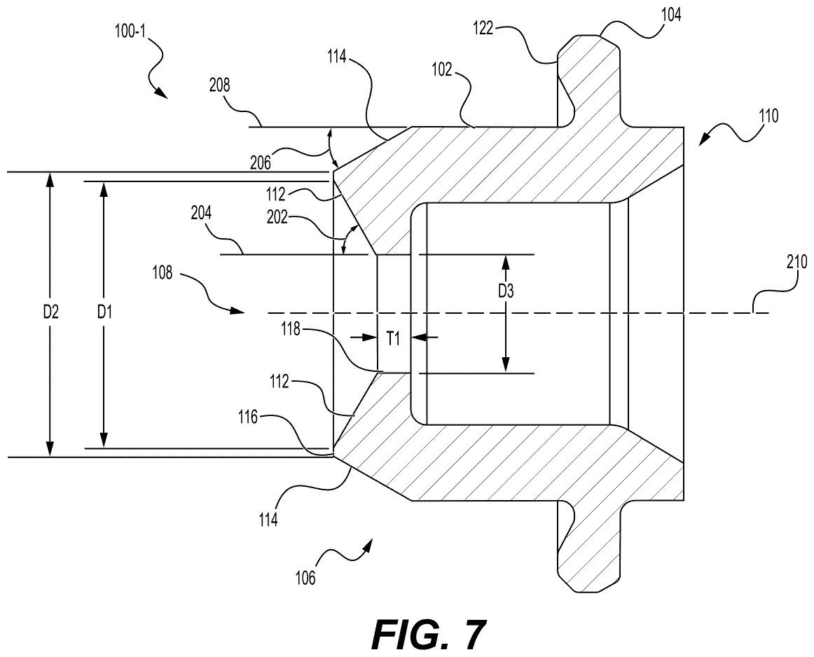

In some examples, the hydraulic control valve 500 may be a fast-reacting electro-hydraulic valve that is able to achieve real-time adjustment of damping forces. The damper 600 including the hydraulic control valve 500 includes the pilot valve 100 discussed above with respect to FIGS. 1-5, which provides a decrease in hydraulic reaction force without altering the solenoid characteristics. The size and shape of the pilot valve features may be optimized according to the disclosure herein for achieving smooth fluid flow, minimizing turbulence, and ensuring consistent flow characteristics. Techniques for obtaining desired force characteristics may be achieved by tuning the hydraulic-fluid-contacting area of the pilot valve 100, i.e., the valve face 108, such as by implementing the valve face configurations discussed above with respect to FIGS. 1-2, and as discussed further below with respect to FIGS. 7-11.

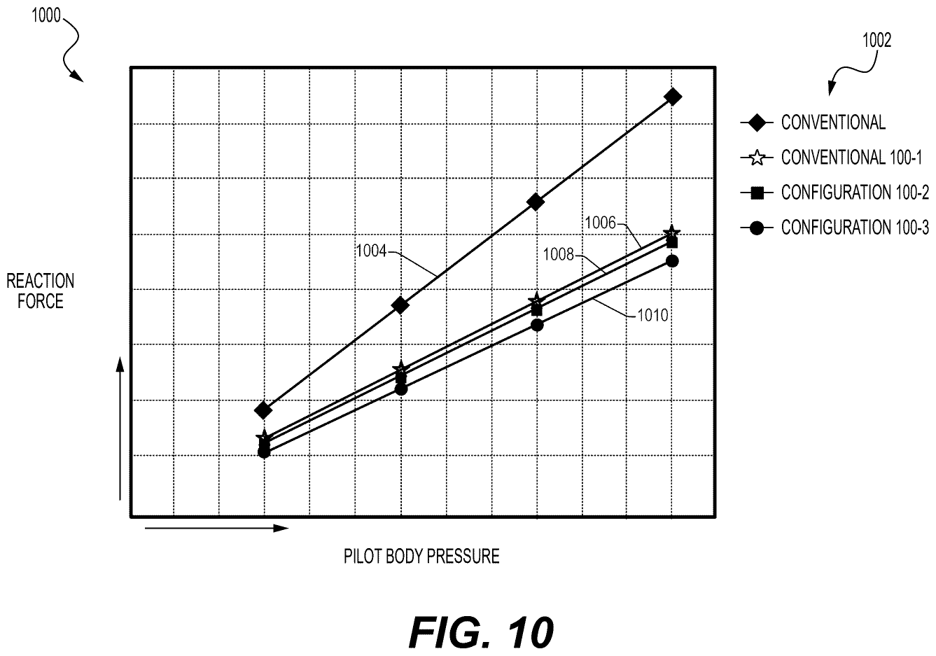

FIGS. 7-9 illustrate cross-sectional views of three example pilot valves having three different example valve face configurations according to some implementations. A predicted reduction in reaction force was determined for each different example using computer model simulation. The results of the computer simulation are discussed below with respect to FIG. 10.

The process of opening (unseating) the pilot valve 100 involves alternating variations of forces acting on the valve face including transitioning between balanced and unbalanced states. The geometrical features of the valve face 108 of the pilot valve 100 in the damper 600 may affect the resistance offered by the damper 600. Accordingly, the hydraulic force acting on the pilot valve 100 can significantly impact the overall performance of the damper 600. To quantify the reaction force of the pilot valve 100, various different valve displacements and hydraulic fluid pressures were simulated using comprehensive three-dimensional (3D) Computational Fluid Dynamics (CFD) methods. For validating the results of the computational models, an example pilot valve 100 was tested on a test rig to determine hydraulic damping force characteristics at various different inputs. A representative example of the simulation model results is presented below with respect to FIG. 10.

FIG. 7 illustrates an example valve face configuration of a pilot valve 100-1 according to some implementations. In the example of FIG. 7, a pilot valve 100-1 includes a valve face 108 having a configuration for decreasing hydraulic reaction forces. In this example, as discussed above with respect to FIGS. 1 and 2, the inner surface 112 of the valve face 108 is shaped as a first truncated cone converging toward the valve body 102 and the second end 110. The outer surface 114 of the valve face 108 is shaped as a second truncated cone that is concentric with the first truncated cone that forms the inner surface 112. The second truncated cone forming the outer surface 114 converges in a direction opposite to the first truncated cone of the inner surface 112 and converges in a direction facing away from the valve body 102, the first end 106, and the second end 110. Further, as mentioned above, the valve face 108 and the pilot valve 100 itself may be generally radially symmetrical about the central axis 210 when viewed from either end 106 or 110 of the pilot valve 100.

In this example, the first angle 202 of the inner surface with respect to the line 204 (which is parallel to the central axis 210) is set at 60 degrees and the second angle 206 of the outer surface 114 with respect to the line 208 extending parallel to the central axis 210 of the pilot valve 100 and from a circumference of the pilot valve body 102 is set at 30 degrees. As one example, the diameter D1 of the

Additionally, in this example, as mentioned above, the valve seating surface 116 may have an inner diameter D1 and an outer diameter D2 that may be sized relative to a valve seat and flow opening of a pilot body 300. The diameter D1 may be sized relative to the diameter D4 of the flow opening 307 of the pilot body as discussed above, such as to be only large enough to be assured of forming a seal between the valve seating surface 116 and the valve seat 302. For example, limiting the diameter of the valve seating surface 116 relative to the flow opening 307 at the valve seat 302 can improve the responsiveness of the pilot valve 100, and thereby improve the responsiveness of a damper 600 in which the pilot valve 100 is installed.

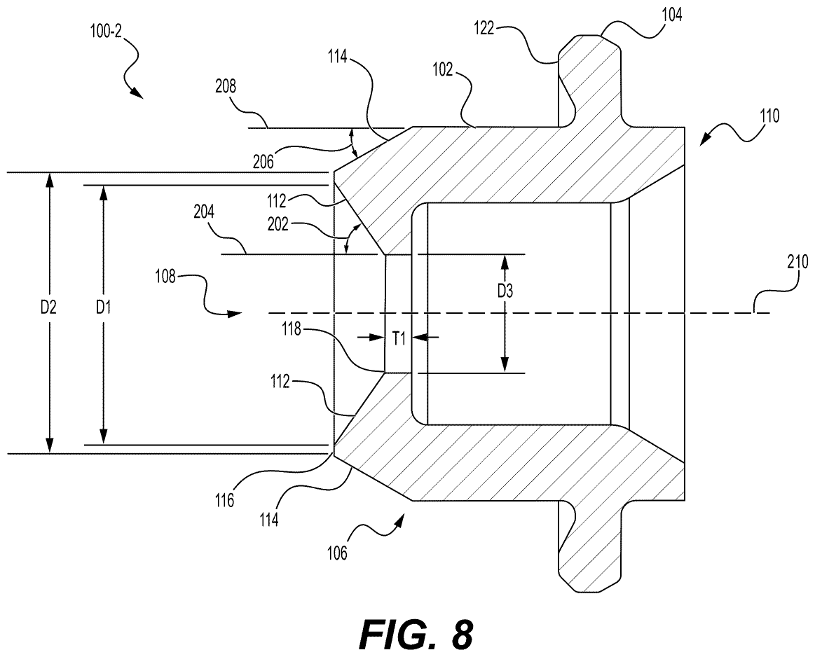

FIG. 8 illustrates another example valve face configuration of a pilot valve 100-2 according to some implementations. The configuration of valve face 108 of FIG. 8 is similar to that discussed above with respect to FIG. 7, except that the first angle 202 is 55 degrees and the second angle 206 is maintained at 30 degrees. To accommodate the steeper first angle, while maintaining the diameter D3 of the opening 118 the same, the thickness T1 of the opening is less. For instance, suppose that in the example of FIG. 7, the thickness T1 is 0.47 mm, and that in the example of FIG. 8, the thickness T1 is 0.4 mm. Further, in this example, suppose that the diameter D1 is also smaller, e.g., 3.5 mm in FIGS. 8 and 3.6 mm in FIG. 7.

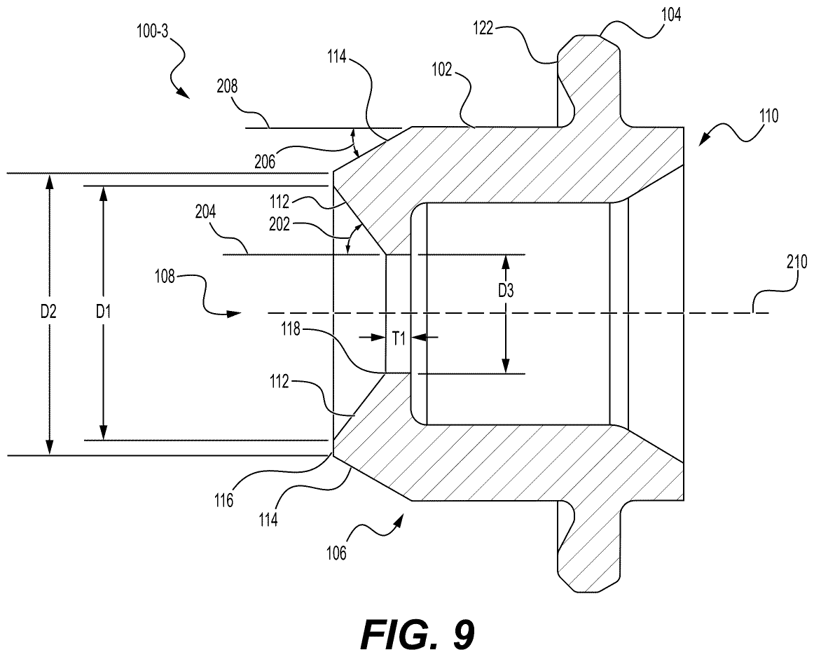

FIG. 9 illustrates another example valve face configuration of a pilot valve 100-3 according to some implementations. The configuration of valve face 108 of FIG. 8 is similar to that discussed above with respect to FIGS. 7 and 8, except that the first angle 202 is 52 degrees and the second angle 206 is maintained at 30 degrees. To accommodate the steeper first angle, while maintaining the diameter D3 of the opening 118 the same, the thickness T1 of the opening is less. For instance, suppose that in the example of FIG. 9, the thickness T1 is 0.3 mm, while in the example of FIG. 7, the thickness T1 is 0.47 mm, and in the example of FIG. 8, the thickness T1 is 0.4 mm. Further, in this example, suppose that the diameter D1 is also smaller, e.g., 3.4 mm, while the diameter D1 may be, e.g., 3.5 mm in FIGS. 8 and 3.6 mm in FIG. 7. Further, based on the example sizes provided above, suppose that the area of the inner surface 112 in FIG. 7 is 9.43 mm², is 9.29 mm² in FIG. 8, and is 8.97 mm² in FIG. 9.

FIG. 10 illustrates an example representative comparison plot 1000 of reaction forces predicted for the different valve face configurations at various pilot body pressures according to some implementations. For instance, semi-active hydraulic dampers, such as the damper 600 described with respect to FIG. 6, are able to optimize vehicle control to improve safety, comfort, and dynamics without compromising the ride or handling characteristics of a vehicle. Semi-active hydraulic dampers solve a particular problem by bridging the gap between vehicle comfort and handling dynamics. On a traditional damper, these two characteristics require opposite tuning methods. While one or the other is easily attainable, together they are not. In principle, semi-active dampers rely on one or two solenoids to receive an electrical signal from a vehicle's electronic chassis controller to mechanically alter the hydraulic flow-path within a damper. This happens within a fraction of a second to attenuate changes to the vehicle's chassis from the road surface or steering maneuvers. As an example, it is not uncommon for the damping force to increase by a magnitude of four times between a “soft” and “firm” mode of the damper settings.

In a semi-active hydraulic damper, the physical changes in the hydraulic circuit are desired to be small with a resulting significant change in hydraulic resistance (measured in terms of “damping force”). A pilot control valve circuit (PVC) that incorporates the pilot valve 100 herein may include a pilot chamber and a main chamber (not shown in FIG. 6). As the pilot chamber builds pressure, it provides a proportional backpressure to the valving of the main chamber. As the larger volume of fluid flows through the main chamber, it is then influenced significantly by the backpressure being built by the pilot chamber. This may increase the PVC circuit's overall resistance and therefore the damping force output of the semi-active hydraulic damper. Having the solenoid 506 located in the pilot chamber provides a significant amount of control for very little mechanical movement. The solenoid 506 is configured, in this scenario, to control the amount of pressure in the pilot chamber by controlling the resistance to the exit flow-path. Specifically, the solenoid provides a holding force to the pilot valve 100 that controls the exit area from the pilot chamber. This holding force is designed to be overcome by hydraulic pressure. Changing the holding force via the solenoid 506 changes how much hydraulic pressure is required to not only open the pilot valve 100, but also to what degree the pilot valve 100 opens. The holding force control is dictated by a commanded change in amperage from the vehicle's electronic chassis controller. Although some applications may vary, an increase in amperage may typically result in increase in holding force, and therefore an increase in the damping force of the damper. The control of the exit area from the pilot chamber significantly influences the damping force output of the damper.

In the example of FIG. 10, the plot 1000 includes a comparison of curves of reaction forces acting on the pilot valve determined via simulation model results for opening of the pilot valve at various different pilot body pressures for a conventional pilot valve and the three example configurations of pilot valves 100-1, 100-2, and 100-3 discussed above with respect to FIGS. 7-9. At 1002, a legend shows the symbols used to indicate the respective curve for each different example valve face configuration. As shown, at 1004 through 1010 in the plot 1000, the reaction force predicted for the conventional pilot valve configuration is higher than the reaction forces predicted for the example configurations 100-1 through 100-3. Further, as indicated at 1003, the reaction force predicted for the configuration 100-3 of FIG. 9 is predicted to be slightly smaller than those predicted for the configuration 100-1 of FIG. 7, and 100-2 of FIG. 8.

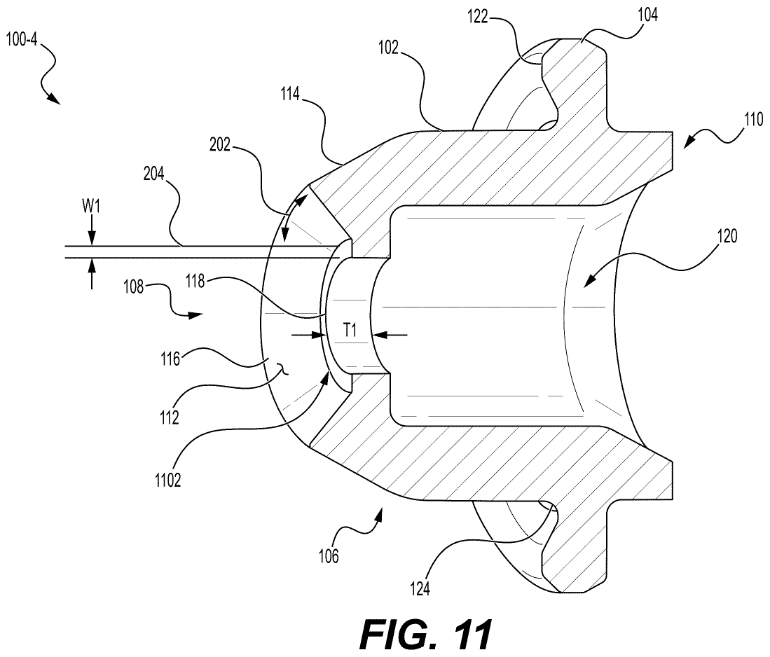

FIG. 11 illustrates another example configuration of a valve face 108 and associated pilot valve 100-4 according to some implementations. In this example, rather than reducing the thickness T1 of the opening 118 for a steeper first angle 102, washer-shaped a circular flat area 1102 having a width W1 may be included around the periphery of the opening 118 for maintaining the opening at the same diameter D3 regardless of the angle of the first angle 102. Further, while several example configurations of valve faces 108 are described herein for purposes of explanation, implementations are not limited to the examples disclosed, but may be extended to various other configurations as would be apparent to those of skill in the art having the benefit of the disclosure herein.

The pilot valve configurations disclosed herein significantly enhance damping force performance of a damper by providing more precise control over the fluid dynamics within the suspension system. Further, significant gains in damping force output may be achieved without any substantial changes to the overall design of a conventional semi-active hydraulic damper, which can lead to substantial performance enhancements without extensive modifications of the semi-active hydraulic damper, making the solution disclosed herein both cost-effective and easily implemented.

The pilot valve 100 herein may be used in various different types of hydraulic fluid systems. In the case of semi-active hydraulic dampers, the pilot valve 100 herein may be suitable for electric vehicles (EVs), autonomous vehicles, luxury vehicles, and performance vehicles where precise control over suspension behavior is more highly valued. For instance, in a semi-active hydraulic damper system, the pilot valve 100 enhances the damping force characteristics to ensure optimal performance across different driving conditions. The improved efficiency of the pilot valve 100 improves damping force characteristics by modulating hydraulic fluid flow accurately and efficiently. The tapered valve face having the first angle greater than the second angle configures the pilot valve 100 to reduce pressure levels on the pilot valve 100. Thus, the examples herein offer a versatile, cost-effective solution for enhancing the suspension systems of a wide range of vehicles, ensuring better comfort, stability, and efficiency. Consequently, examples herein address issues in conventional pilot valve technology by introducing features in pilot valve design that enhance fluid flow control, allowing for more precise regulation of hydraulic fluid within a damper system, or the like. This improvement directly contributes to more accurate adjustments of the damping force characteristics, enabling, for example, a semi-active damper to respond more effectively to dynamic changes in driving conditions and road surfaces.

This disclosure provides various example implementations, as described and illustrated in the drawings. However, this disclosure is not limited to the implementations described and illustrated herein, but can extend to other implementations, as would be known or as would become known to those skilled in the art. Additionally, while this disclosure describes or illustrates particular embodiments as providing particular advantages, some claimed embodiments may provide none, some, or all of these advantages.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

What is claimed:

1. A valve apparatus comprising:
a valve including a valve body having a central axis, a valve face disposed on a first end of the valve body, the valve face including an outer surface and an inner surface that meet at an apex at which a circular valve seating surface is disposed, the inner surface shaped as a first truncated cone converging in a first direction toward the valve body and the outer surface shaped as a second truncated cone converging in a second direction away from the valve body, the inner surface having a first angle relative to the central axis, the outer surface having a second angle relative to a line extending from a circumference of the valve body and parallel to the central axis, wherein the first angle of the inner surface is greater than the second angle of the outer surface; and
a pilot body having a fluid flow passage opening with a valve seat surrounding the fluid flow passage opening, the circular valve seating surface of the valve configured to contact the valve seat in a first position for forming a seal to prevent passage of fluid between the circular valve seating surface and the valve seat, the valve movable from the first position to a second position to enable passage of fluid between the circular valve seating surface and the valve seat.

2. The valve apparatus as recited in claim 1, wherein the first angle is between 45 and 65 degrees and the second angle is between 20 and 40 degrees.

3. The valve apparatus as recited in claim 1, wherein the first angle is between 30 and 80 degrees and the second angle is between 0 and 45 degrees, the first angle remaining greater than the second angle.

4. The valve apparatus as recited in claim 1, wherein the valve body is cylindrical and the inner surface includes an opening in a center thereof opening into a bore of the cylindrical valve body.

5. The valve apparatus as recited in claim 1, wherein a diameter of the circular valve seating surface is controlled relative to a diameter of the fluid flow passage opening for minimizing an amount of fluid pressure needed for moving the valve to the second position.

6. The valve apparatus as recited in claim 1, wherein the valve body includes an opening at a second end thereof, with an inner bore configured to receive a plunger end of a plunger, the plunger configured to press the circular valve seating surface of the valve against the valve seat in the first position.

7. The valve apparatus as recited in claim 6, wherein the valve and pilot body are included in a hydraulic control valve including a solenoid configured to be activated for causing the plunger to press the circular valve seating surface against the valve seat.

8. The valve apparatus as recited in claim 7, wherein:
the hydraulic control valve is in fluid communication with a damper, and
a configuration of the valve face reduces an amount of fluid pressure for pushing the circular valve seating surface away from the valve seat to enhance responsiveness of the damper.

9. The valve apparatus as recited in claim 1, further comprising a washer-shaped flat area disposed between the inner surface and a periphery of an opening concentric with the inner surface.

10. A damper comprising:
an inner tube with a piston and piston rod configured to reciprocate within the inner tube;
an outer tube disposed around the inner tube;
a hydraulic control valve in fluid communication with an interior of the outer tube for receiving fluid from the damper and returning fluid to the damper;
a valve disposed in the hydraulic control valve, the valve including a valve face having an outer surface and an inner surface that meet at an apex at which a circular valve seating surface is disposed, the inner surface shaped as a first truncated cone converging in a first direction toward the valve body and the outer surface shaped as a second truncated cone converging in a second direction away from the valve body, the inner surface having a first angle relative to the central axis, the outer surface having a second angle relative to a line extending from a circumference of the valve body and parallel to the central axis, wherein the first angle of the inner surface is greater than the second angle of the outer surface; and
a pilot body disposed in the hydraulic control valve, the pilot body having a fluid flow passage opening with a valve seat surrounding the fluid flow passage opening, the circular valve seating surface configured to contact the valve seat in a first position for forming a seal to prevent passage of fluid between the circular valve seating surface and the valve seat, the valve movable from the first position to a second position to enable passage of fluid between the circular valve seating surface and the valve seat.

11. The damper as recited in claim 10, wherein the first angle is between 45 and 65 degrees and the second angle is between 20 and 40 degrees.

12. The damper as recited in claim 10, wherein a diameter of the circular valve seating surface is controlled relative to a diameter of the fluid flow passage opening for minimizing an amount of fluid pressure needed for moving the valve to the second position.

13. The damper as recited in claim 10, the hydraulic control valve further comprising a solenoid having a plunger, with a plunger end of the plunger disposed in an inner bore of the valve body, the solenoid configured to be activated for causing the plunger to press the circular valve seating surface against the valve seat.

14. The damper as recited in claim 10, further comprising an intermediate tube disposed around at least a portion of the inner tube in an annular space between the inner tube and the outer tube, the intermediate tube configured to receive fluid and pass the fluid into the hydraulic control valve.

15. The damper as recited in claim 10, wherein the damper is a semi-active hydraulic damper.

16. A valve apparatus for forming a seal with a valve seat disposed around a periphery of a fluid flow passage, the valve apparatus comprising:
a valve including a valve body having a central axis, a valve face disposed on a first end of the valve body, the valve face including an outer surface and an inner surface with a circular valve seating surface disposed between the inner surface and the outer surface, the inner surface shaped as a first truncated cone converging in a first direction toward the valve body and the outer surface shaped as a second truncated cone converging in a second direction away from the valve body, the inner surface having a first angle relative to the central axis, the outer surface having a second angle relative to a line extending from an exterior of the valve body and parallel to the central axis, wherein the first angle of the inner surface is greater than the second angle of the outer surface, the circular valve seating surface disposed for forming the seal with the valve seat.

17. The valve apparatus as recited in claim 16, wherein the first angle is between 45 and 65 degrees and the second angle is between 20 and 40 degrees.

18. The valve apparatus as recited in claim 16, wherein the circular valve seating surface of the valve is configured to contact the valve seat in a first position for forming the seal with the valve seat to prevent passage of fluid between the circular valve seating surface and the valve seat, the valve movable from the first position to a second position to enable passage of fluid between the circular valve seating surface and the valve seat.

19. The valve apparatus as recited in claim 18, wherein the valve body includes an opening at a second end thereof, with an inner bore configured to receive a plunger end of a plunger, the plunger configured to press the circular valve seating surface of the valve against the valve seat in the first position.

20. The valve apparatus as recited in claim 19, wherein the valve is included in a hydraulic control valve including a solenoid configured to be activated for causing the plunger to press the circular valve seating surface against the valve seat.
